(19) United States
(12) Patent Application Publication
(10) Pub. No.: US 2008/0288432 A1
(43) Pub. Date: Nov. 20, 2008

(54) Device and Method of Fixing Wireless Network Problems

(76) Inventors: Ajay MALIK, San Jose, CA (US); Mahender Vangati, San Jose, CA (US)

Correspondence Address: FAY KAPLUN & MARCIN, LLP, 150 BROADWAY, SUITE 702, NEW YORK, NY, 10038, US

(21) Appl. No.: 11/876,561

(22) Filed: Oct. 22, 2007

Related U.S. Application Data
(60) Provisional application No. 60/938,556, filed on May 17, 2007.

(51) Int. Cl. G06N 5/02

(52) U.S. Cl. 706/47

(57) ABSTRACT

A method is used to fix wireless network problems. The method comprises receiving at least one parameter relating to a wireless network. The method comprises comparing the at least one parameter with a database of problem identities. Each problem identity has a set of criteria. The at least one parameter relates to the set of criteria. The method comprises determining at least one problem with the wireless network based on the comparison of the at least one parameter with the problem identities.

### PRIORITY CLAIM

This application claims the priority to the U.S. Provisional Application Ser. No. 60/938,556, entitled “System and Method of Fixing Wireless Network Problems,” filed May 17, 2007. The specification of the above-identified application is incorporated herewith by reference.

### FIELD OF THE INVENTION

The present invention relates generally to a device and method of fixing wireless network problems. Specifically, a set of rules and a logic engine determine how to address the wireless network problems.

### BACKGROUND INFORMATION

Wireless network problems may be very complex, thereby making troubleshooting and fixing the problems complex. Wireless network problems may depend on a variety of factors beyond a wired network. For example, characteristics of a facility/environment may play a larger role in terms of network problems when dealing with a wireless network. Furthermore, characteristics of the facility/environment are dynamic in nature. Through complex graphs, topology maps, etc., expertise is necessary to determine problems associated with wireless networks. Consequently, wireless network problems require an expert to analyze the problem and study all the aspects of the network in order to properly implement a solution. Accordingly, it is very expensive and requires network experts to solve wireless network problems.

### SUMMARY OF THE INVENTION

The present invention relates to a device and method fixing wireless network problems. The method comprises receiving at least one parameter relating to a wireless network. The method comprises comparing the at least one parameter with a database of problem identities. Each problem identity has a set of criteria. The at least one parameter relates to the set of criteria. The method comprises determining at least one problem with the wireless network based on the comparison of the at least one parameter with the problem identities.

### DESCRIPTION OF THE DRAWINGS

FIG. 1 shows a wireless system according to an exemplary embodiment of the present invention.

FIG. 2 shows an exemplary wireless server disposed in the wireless system of FIG. 1.

FIG. 3 shows a method of addressing wireless network problems according to an exemplary embodiment of the present invention.

### DETAILED DESCRIPTION

The exemplary embodiments of the present invention may be further understood with reference to the following description and the appended drawings, wherein like elements are referred to with the same reference numerals. The exemplary embodiments of the present invention describe a system and method for diagnosing and fixing problems associated with a wireless network. According to the exemplary embodiments of the present invention, a logic engine processes the parameters of the network associated with the problem and outputs a solution to address the problem. The logic engine, problems, and solutions will be discussed in more detail below.

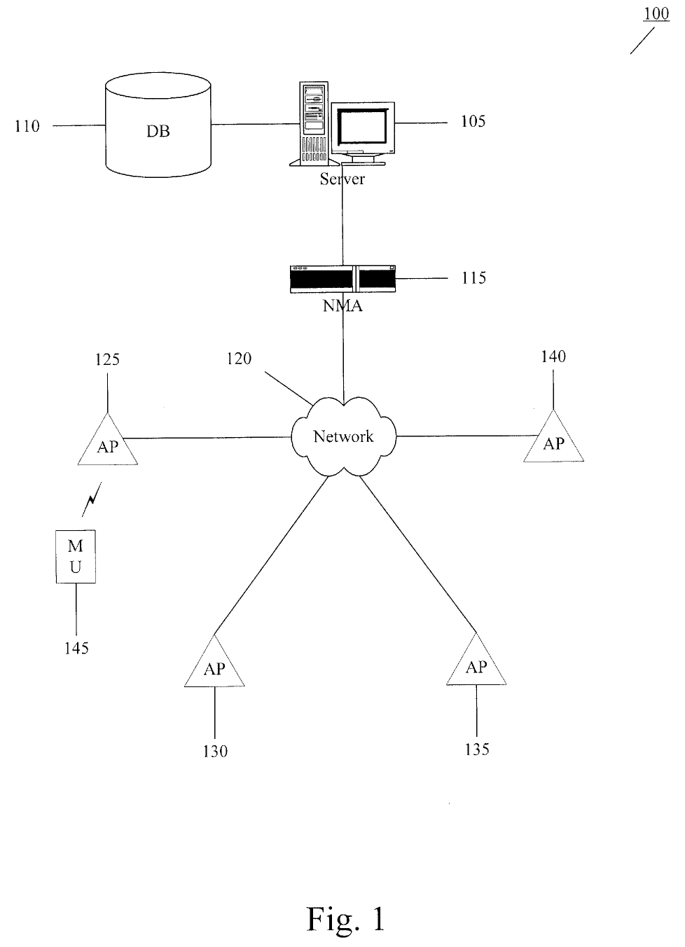

FIG. 1 shows a wireless system 100 according to an exemplary embodiment of the present invention. A wireless server 105 may be connected to a network management arrangement (NMA) 115. The wireless server 105 may further be connected to a database 110. The NMA 115 may be connected to a network 120. Access points (AP) 125-140 may be connected to the network 120. The network 120 may be a wired, a wireless communication network, or a combination thereof. The network 120 may incorporate the APs 125-140 to extend a coverage area so that a mobile unit (MU) (e.g., MU 145) may connect to the network 120 in a greater number of locations. The APs 125-140 may contain an individual coverage area that is a part of a total coverage area of the network 120. If the MU 145 is connected to an AP, the MU 145 may travel within the coverage area of that AP. As the MU 125 exits the coverage area of that AP, the MU 145 may connect to a neighboring AP to maintain the connection to the network (i.e., roam).

Those skilled in the art will understand that the system 100 is an exemplary system on which an exemplary embodiment of the present invention may be implemented. The present invention is not limited to any particular network topology, but may be implemented on any type of network. For example, each of the APs 125-140 may be connected to a different NMA, may operate under the same NMA 115, or the system 100 may not include the NMA 115. Thus, the present invention may be implemented in any network.

As shown in FIG. 1, the MU 145 may be communicating with the AP 125 and may roam to the coverage areas of any of the APs 130-140. It should be noted that the wireless system 100 shown in FIG. 1 is only exemplary and there may be fewer or more APs and the MU 145 may be initially communicating with any of the APs 130-140. In the exemplary embodiment, each of the APs 125-140 includes a coverage area that may overlap or be adjacent to the coverage area of the AP 125. Thus, when the MU 145 roams from the AP 125, it may enter the coverage area of any of the APs 130-140. It should also be noted that the wireless system 100 is only exemplary and other systems may include other components (e.g., wireless switches, network appliances, additional servers, printers, etc.). For example, if the wireless system 100 included a wireless switch, the APs 125-140 may be thin APs since the switch may control a manner in which data is exchanged throughout the wireless system 100.

The MU 145 roaming from one AP to another AP may attribute to the further complexity associated with the problems pertaining to networks that include wireless components such as the network 120. For example, with hard-wired networks, the server, NMA, etc. may easily determine a location in which the network device is located since the device is directly connected to the server, an access point, etc. If the hard-wired network device moves to a different access point, then another hard-wired connection is made, thereby allowing the server, NMA, etc. to know the device location. In contrast to hard-wired networks, the wireless network may include MUs (e.g., MU 145) that first requires locating. At any given instance, the MU 145 may be located in a variety of locations. To first locate the MU 145 may require several additional steps. In another example, those skilled in the art understand that a coverage area of an AP is three-dimensionally radial. Thus, locating an MU or discovering a problem with connectivity may further require an analysis beyond two-dimensions. Other aspects of wireless networks that make troubleshooting and fixing problems difficult such as signal strengths, RF interference, etc.

In addition, there may be multiple types of MUs connected to the network, e.g., mobile computers, voice communication devices, RFID devices, bar code readers, etc. Each of these devices may include different software, different communication devices, different protocol stacks, different amounts of memory, etc. Each of these variables lends to additional complexity in diagnosing a network problem.

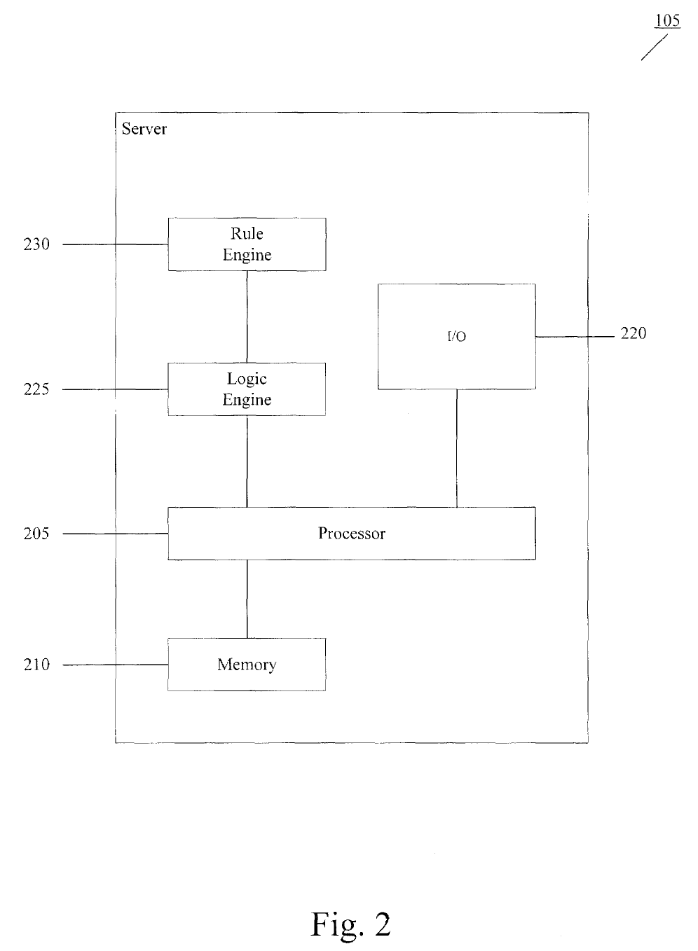

FIG. 2 shows the exemplary wireless server 105 disposed in the wireless system 100 of FIG. 1. The wireless server 105 may run specific server applications such as those necessary to operate a network. The wireless server 105 may also provide various network services to network devices (e.g., wired and/or wireless devices). The wireless server 105 may include a processor 205, a memory 210, input/output (I/O) 220, a logic engine 225, and a rule engine 230. It should be noted that the wireless server 105 may include further hardware and/or software such as a location engine to determine location of MUs within the wireless network 120, etc.

The processor 205 may be a central component that operates the wireless server 105. The processor 205 may include conventional functionalities included in processors found in conventional network servers. The processor 205 may also include additional functionalities related to logic and rules, as will be discussed in further detail below. The I/O 220 may include a communication device used to send/receive data to/from the network. The I/O 220 may also include conventional functionalities included in network servers. The memory 210 may store data related to the wireless server 105, include programs executed by the wireless server 105, store data received from the network, etc.

The logic engine 225 may be a system or process that analyzes problems associated with the network 120. That is, the logic engine 225 may be an intelligence engine that receives data in order to identify a problem. The logic engine 225 may further include a functionality that, upon identification of the problem, determines a possible solution to the problem. The logic engine 225 may be driven using a variety of methods. For example, the logic engine 225 may include an algorithm that is rule-based. The rule-based algorithm may compare a set of parameters of the wireless network 120 to a list of problems, each problem with a threshold of parameters. The threshold of parameters may indicate that when at least one, at least two, every parameter, etc. of the set of parameters is beyond the threshold of parameters, a specific problem is identified. If the logic engine 225 determines that there are multiple problems associated with the set of parameters, the logic engine 225 may assign a confidence level to the different types of identified problems. In addition, the logic engine 225 may determine a potential location in which the problem is occurring, narrowing the potential solutions. The rule-based algorithm may cross-reference the problem with a set of solutions. A list of possible solutions may be output.

The logic engine 225 may further include a functionality that gives a confidence level associated with each solution in the set of solutions. For example, when a problem X has been identified in the network 120, a set of solutions may include solutions A, B, and C. Through past experiences and common troubleshooting, solution A has had a higher probability of success while solution B had a lower probability of success and solution C had the least probability of success. The logic engine may include these confidence levels with each solution. The confidence levels may also be given in other formats such as percentages. According to the exemplary embodiments of the present invention, the logic engine 225 running as a rule-based algorithm may be accomplished by functioning with the rule engine 230.

The rule engine 230 may include a set of rules relating to problems associated with the wireless network 120, thereby being the basis for the logic engine 225 to identify and propose solutions. In one exemplary embodiment, the rule engine 230 may be a database of rules stored in the memory 210, each rule indicating criteria. As discussed above, the logic engine 225 may compare the set of parameters collected for the network 120 to the rules contained in the rule engine 230. If the set of parameters satisfies the criteria associated with a problem, then a match is output as a problem of the network 120. It should be noted that multiple matches may occur and the logic engine 225 may output more than one potential problem. These matches may further indicate the location of the problem. The rule engine 230 may also include a database of solutions associated with each problem, being further able to be broken down depending on location. This database may indicate a list of potential solutions depending on the identified problem. The database of solutions may also include the confidence level associated with each solution, depending on the identified problem.

The logic engine 225 and the rule engine 230 may be equipped with a standard algorithm and databases, respectively. For example, the algorithm and databases may be static. The logic engine 225 and the rule engine 230 may also be equipped with an updateable algorithm and databases. Updates may be manually performed by an administrator or the updates may be automatic such as with learning algorithms and learning databases. Through further experience troubleshooting and fixing problems of wireless networks, the logic engine 225 and the rule engine 230 may include problems and solutions that were originally not included in the initial algorithm and databases. Furthermore, learning algorithms and learning databases may be more efficient and beneficial to the wireless network due to the dynamic and individual characteristics of each network.

It should be noted that the logic engine 225 and the rule engine 230 being disposed as a separate unit is only exemplary. For example, the logic engine 225, the rule engine 230, or both may be a software program that may be stored on the memory 210 and executed by the processor 205.

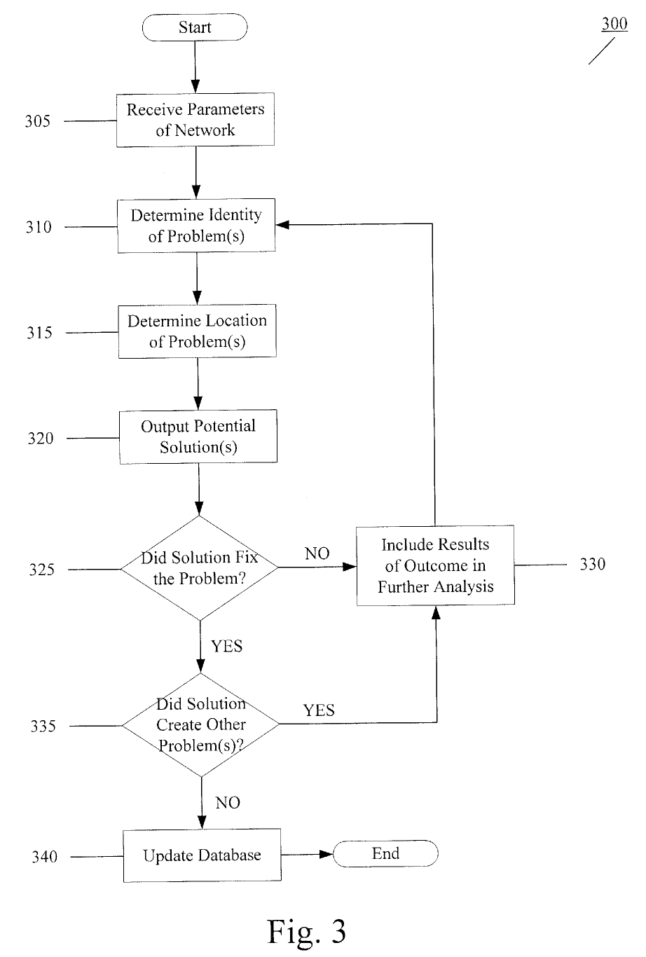

FIG. 3 shows a method 300 of addressing wireless network problems according to an exemplary embodiment of the present invention. The method 300 will be described with reference to the system 100 of FIG. 1 and the components of the server 105 of FIG. 2. The method 300 utilizes the logic engine 225 in tandem with the rule engine 230 in order to determine a problem of the wireless network 120 and also provide possible solutions to resolve the problem.

In step 305, parameters of the wireless network 120 are received. The parameters of the wireless network 120 may include a wide range of possibilities. For example, the parameters may include data pertaining to a number of connections, received signal strength indication (RSSI), MU locations, roaming times, network topology, network throughput, device operation (e.g., battery level), etc. The received parameters may include the entire set of data pertaining to the wireless network 120.

In step 310, the identity of the problem is determined. As discussed above, the logic engine 225 functions with the rule engine 230 to determine the problem. For example, the cross-referencing of the parameters of the wireless network 120 may be done with the rules contained in the rule engine 230. It should be noted that a particular problem may only require a portion of the parameters received in step 305. That is, a problem concerning roaming may require substantially the entire set of parameters that are received but a problem concerning energy use may require less parameters. It should be noted that multiple problems may be identified in step 310.

In step 315, the location of the problem is determined. As discussed above, the logic engine 225 and the rule engine 230 may include the algorithm and database to further identify a particular site within the wireless network 120 where the problem may be located. For example, if a roaming problem is identified in step 310, the location may be at the AP, the server 105, a particular MU, etc.

In step 320, potential solutions are output. As discussed above, the logic engine 225 and the rule engine 230 may include the algorithm and database to identify solutions related to the identified problem. With each problem identified, a set of solutions is offered to resolve the problem. Furthermore, confidence levels may be associated with each solution in the set. The set of solutions may be further broken down to be associated with each location in which a problem may be located.

In step 325, a determination is made whether the solution fixed the problem. The implementation of the solution may be done in a variety of ways. For example, an administrator may manually perform the proposed solution. In another example, the system 100 may automatically perform the proposed solution. The automatic process may be done according to the confidence levels associated with each solution. In yet another example, a combination of manual and automatic actions may be performed.

If step 325 determines that the problem has not been fixed, the method 300 continues to step 330. In step 330, the results of implementing the solution are included with the parameters of the wireless network 305 so that in a further analysis, the results may be taken into consideration. The method 300 would return to step 310 where the identity of the problem is again determined. It should be noted that the method 300 may return to other steps as well. For example, given the parameters of the wireless network 120, the logic engine 225 and the rule engine 230 determine that the wireless network 120 contains a particular problem and no possible other problems. Then the method 300 may go from step 330 and return to step 320, where a solution is output considering the results of the last run.

If step 325 determines that the solution fixed the problem, then the method 300 continues to step 335. In step 335, a determination is made whether the solution that fixed the problem created other problems that were not previously present. For example, to address a gap in coverage for the wireless network 120, a power setting for the AP 140 was increased. The gap in the coverage was thereby eliminated. However, the increased power setting for the AP 140 may result in a power consumption that is beyond an acceptable limit for the overall system 100. Thus, if step 335 determines that additional problems are created, the method 300 continues to step 330 so that additional processing may be performed to eliminate each and every problem associated with the wireless network 120.

It should be noted that the solution that fixes the identified problem may be an only solution that exists with current technology. In such an embodiment, the method 300 may include additional steps to address this situation. For example, if step 335 determines that the solution does create other problems, another determination may be made to determine if the solution is the only way to solve the identified problem. If other solutions exist, the method 300 may continue to step 330 so that further processing may take place to find at least one other solution that does not cause other problems. If no other solution exists, the method 300 may incorporate the solution and continue to step 330 where the results (e.g., other problems, sole solution, etc.) are included for the further analysis. In addition, the method 300 may return to step 305 so that new parameters of the network may be received relating to the other problems that were created.

If step 335 determines that the solution that fixed the problem does not create other problems, the method 300 continues to step 340. In step 340, the database is updated. The update of the database may take a variety of forms. For example, the database of the rule engine 230 may include the results of the process. The rule engine 230 may record the solutions that succeeded and the solutions that did not succeed (i.e., if the method 300 had to return via step 330). The updating of the rule engine 230 allows a further modification of confidence levels, a higher likelihood of identifying a problem (especially given substantially similar parameters), etc. In another example, the algorithm of the logic engine 225 may include the results of the process. The logic engine may incorporate the process taken. A more efficient algorithm may be output for subsequent runs of the process, particularly if the recorded process required a return via step 330. Once the database is updated, the method 300 ends.

It should be noted that the use of the server 105 to include the logic engine 225 and the rule engine 230 is only exemplary. The logic engine 225 and the rule engine 230 may be disposed in a variety of network devices. For example, they may be located on the NMA 115, on each AP 125-140, etc. Thus, the method 300 may be carried out by each of these network devices. Furthermore, the logic engine 225 and the rule engine 230 may be disposed on multiple network devices so that a more thorough analysis of the problem may be done. By having multiple network devices performing the method 300, a narrow set of solutions may be presented with a high probability of success to resolve the problem.

The following describes an exemplary problem and solution to the problem utilizing the exemplary system 100 and the exemplary method 300 described above. The exemplary problem relates to a data exchange rate including a volume of data exchanged and a time taken to exchange the volume.

Initially, the server 105 may receive parameters related to the network 120. The parameters may include the volume of data. For example, the server 105 may receive parameters specifically related to the AP 125. The server 105 may receive a parameter indicating that a high volume of data was received via the AP 125. An additional parameter specifically related to the AP may relate to an overall time spent on exchanging the volume of data. The server 105 may subsequently calculate an average rate in which the volume was exchanged. The average exchange rate for the AP 125 may be compared to a predetermined minimum in which data is to be exchanged within the network 120. Yet another parameter may relate to a number of devices such as MUs that are connected (e.g., wired, wireless, or a combination thereof) to the AP 125. The parameter may indicate that a large number of MUs were connected to the AP 125 during the data volume exchange.

The average exchange rate for the AP 125 may be determined to be lower than the predetermined minimum (e.g., high volume with long time). Thus, the server 105 may determine that a problem associated with the network 120 is that the exchange rate for the AP 125 is too low. The server 105 may also determine that the problem may be located in a variety of locations. For example, the problem may be located at the AP 125, at the MUs connected to the AP 125, at a destination component, etc. However, the server 105 may initially attempt to solve the low data exchange rate by altering an operating parameter of the AP 125 due to the large number of MUs that were connected.

The server 105 may output several potential solutions. For example, a first solution may be to require MUs disposed in an area of the network 120 that is covered by more than one AP (i.e., multiple operating areas) to connect to an AP other than the AP 125. Thus, if the MU 145 is in an operating area of the AP 125 and the AP 130, then the MU 145 is to connect to the AP 130 when the above parameters exist. Accordingly, the removal of the MU 145 exchanging data via the AP 125 may alleviate the total volume of data and increase an available bandwidth provided by the AP 125. In another example, a second solution may be to increase an allotted bandwidth reserved for the AP 125. The increased bandwidth may require an increased power provided to the AP 125 so that an increased data exchange rate may be achieved.

The server 105 may attempt to fix the low data exchange rate problem by utilizing the first potential solution (i.e., make MUs in multiple operating zones to connect to the network 120 with a different AP). The server 105 may receive subsequent parameters of the network 120 including the data exchange rate of the AP 125. The server 105 may additionally receive parameters relating to the other APs, in particular the APs with an overlapping operating zone with the AP 125.

The subsequent parameters may indicate that the data exchange rate of the AP 125 has reached at least the predetermined minimum threshold. Thus, the first potential solution solved the problem. However, the parameters related to other APs may indicate that the data exchange rate has dropped below the predetermined minimum threshold. For example, the AP 130 previously abided by the threshold but with the increased MUs connecting thereto, the data exchange rate has been lowered beyond the threshold.

The subsequent parameters of the network 120 may be included in determining whether to implement the potential solution. In a first subsequent step, if the server 105 determines that the lowered data exchange rate of the AP 130 is unacceptable, then the first potential solution may not be implemented. The server 105 may then attempt to solve the lowered data exchange rate for the AP 125 by increasing the allotted bandwidth. In a second subsequent step, the server 105 may implement the first potential solution and further address the other problems (e.g., lowered data exchange rate for the AP 130).

In this manner, the server 105 including the rule engine 230 and the logic engine 225 may be a learning algorithm as further experiences (e.g., problems and attempted solutions) are had. Thus, if the network 120 experiences a substantially similar problem with alike parameters, the server 105 may readily fix the problem. Furthermore, the server 105 may be equipped with a list of potential solutions and a quality rating. The quality rating may indicate a rate of success associated with each potential solution.

Those skilled in the art will understand that the above described exemplary embodiments may be implemented in any number of manners, including, as a separate software module, as a combination of hardware and software, etc. For example, the logic engine 225 and the rule engine 230 may be a program containing lines of code that, when compiled, may be executed on the processor 110.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A method, comprising:
receiving at least one parameter relating to a wireless network;
comparing the at least one parameter with a database of problem identities, wherein each problem identity has a set of criteria, the at least one parameter relating to the set of criteria; and
determining at least one problem with the wireless network based on the comparison of the at least one parameter with the problem identities.

2. The method of claim 1, further comprising:
providing a proposed solution to the problem.

3. The method of claim 2, further comprising:
determining if the proposed solution creates at least one further problem when implemented.

4. The method of claim 3, wherein the proposed solution is an only solution to the problem.

5. The method of claim 4, further comprising:
implementing the proposed solution; and
determining a further proposed solution for each of the at least one further problem.

6. The method of claim 1, further comprising:
determining if the at least one problem is new;
creating a problem identity for the new problem; and
recording at least one parameter related to the new problem to serve as the set of criteria for the new problem.

7. The method of claim 2, further comprising:
determining if the proposed solution corrected the at least one problem.

8. The method of claim 7, further comprising:
incorporating results when the proposed solution is successful.

9. The method of claim 7, further comprising:
incorporating results when the proposed solution fails.

10. A device, comprising:
an input component receiving at least one parameter relating to a wireless network;
a memory having a rule engine including a database of problem identities, each problem identity having a set of criteria; and
a processor comparing the at least one parameter to the set of criteria to determine a problem associated with a wireless network.

11. The device of claim 10, wherein the processor provides a proposed solution to the problem.

12. The device of claim 11, wherein the processor determines if the proposed solution creates at least one further problem when implemented.

13. The device of claim 12, wherein the proposed solution is an only solution to the problem.

14. The device of claim 13, wherein the proposed solution is implemented on the wireless network and the processor determines a further proposed solution for each of the at least one further problem.

15. The device of claim 10, wherein if the processor determines if the problem is new, a problem identity for the new problem is created on the rule engine and at least one parameter relating to the new problem is associated with the new problem to serve as the set of criteria for the new problem.

16. The device of claim 11, wherein the processor determines if the proposed solution corrected the at least one problem.

17. The device of claim 16, wherein the processor incorporates results when the proposed solution is successful.

18. The device of claim 16, wherein the processor incorporates results when the proposed solution fails.

19. A computer readable storage medium including a set of instructions executable by a processor, the set of instructions operable to:
receive at least one parameter relating to a wireless network;
compare the at least one parameter with a database of problem identities, wherein each problem identity has a set of criteria, the at least one parameter relating to the set of criteria; and
determine at least one problem with the wireless network based on the comparison of the at least one parameter with the problem identities.

20. A device, comprising:
an input means for receiving at least one parameter relating to a wireless network;
a storing means for storing a rule engine including a database of problem identities, each problem identity having a set of criteria; and
a processing means for comparing the at least one parameter to the set of criteria to determine a problem associated with a wireless network.
